(19) United States
(12) Patent Application Publication
(10) Pub. No.: US 2018/0300742 A1
(43) Pub. Date: Oct. 18, 2018

(54) INFORMATION PROCESSING DEVICE, INFORMATION PROCESSING METHOD, AND INFORMATION PROCESSING SYSTEM

(71) Applicant: FeliCa Networks, Inc., Tokyo (JP)

(72) Inventors: Jun TADA, Tokyo (JP); Daisuke MOTOKAWA, Chiba (JP)

(73) Assignee: FeliCa Networks, Inc., Tokyo (JP)

(21) Appl. No.: 15/770,889

(22) PCT Filed: Nov. 1, 2016
(86) PCT No.: PCT/JP2016/082398

§ 371 Date: Apr. 25, 2018

(30) Foreign Application Priority Data
Nov. 26, 2015 (JP) 2015-230517
Sep. 12, 2016 (JP) 2016-177679

(51) Int. Cl. G06Q 30/02; G06Q 20/08

(52) U.S. Cl. CPC G06Q 30/0226; G06Q 20/08

(57) ABSTRACT

Provided is an information processing device including a processing unit configured to associate payment information with giving information used to give a point, and cause the payment information and the giving information that are associated with each other to be transmitted to a transmission target.

### TECHNICAL FIELD

The present disclosure relates to an information processing device, an information processing method, and an information processing system,

### BACKGROUND ART

There has been diffused a point service in which a point is given on the basis of content of payment performed at the time of purchasing commodities or using services. There has also been developed a technology that manages data of a plurality of point services by using a single device. The technology that manages data of a plurality of point services by using a single device is, for example, a technology disclosed in Patent Literature 1 cited below.

### CITATION LIST

### Patent Literature

Patent Literature 1: JP 2005-78185A

### DISCLOSURE OF INVENTION

### Technical Problem

For example, the use of a device to which the technology that manages data of a plurality of point services by using a single device such as the technology disclosed in Patent Literature 1 is applied allows a user to receive provision of a plurality of point services by using a single device without bringing a plurality of cards for receiving the point services (so-called point cards). Therefore, the use of the existing technology that manages data of a plurality of point services by using a single device can improve convenience for the user.

However, even in a case in which the user possesses a device to which the above existing technology is applied, a point service cannot be provided to the user unless the device is presented to a person who performs operation related to payment such as a salesperson at the time of payment or the like. Therefore, even in a case in which the user possesses a device to which the above existing technology is applied, no point cannot be given to the user unless the device is presented to a person who performs operation related to payment such as a salesperson at the time of payment or the like.

The present disclosure proposes an information processing device, an information processing method, and an information processing system, each of which is new, is improved, and is capable of achieving giving a point based on payment without requiring that a user present a card or the like for receiving a point service.

### Solution to Problem

According to the present disclosure, there is provided an information processing device including a processing unit configured to associate payment information with giving information used to give a point, and cause the payment information and the giving information that are associated with each other to be transmitted to a transmission target.

In addition, according to the present disclosure, there is provided an information processing method executed by an information processing device, the information processing method including a step of associating payment information with giving information used to give a point and causing the payment information and the giving information that are associated with each other to be transmitted to a transmission target.

In addition, according to the present disclosure, there is provided an information processing system including: an information processing device including a processing unit configured to associate payment information with giving information used to give a point and configured to cause the payment information and the giving information that are associated with each other to be transmitted to a first processing device serving as a transmission target; and the first processing device configured to cause a process of giving a point to be performed on a basis of the acquired payment information and giving information and sales information of a payment place.

In addition, according to the present disclosure, there is provided an information processing system including: an information processing device including a processing unit configured to associate payment information with giving information used to give a point and configured to cause the payment information and the giving information that are associated with each other to be transmitted to a second processing device serving as a transmission target; and the second processing device configured to perform a process of giving a point on a basis of the acquired payment information and giving information and sales information of a payment place.

In addition, according to the present disclosure, there is provided an information processing system including: an information processing device including a processing unit configured to associate payment information with giving information used to give a point and configured to cause the payment information and the giving information that are associated with each other to be transmitted to a first processing device serving as a transmission target; the first processing device configured to cause a second processing device to perform a process of giving a

point on a basis of the payment information and the giving information that are acquired from the information processing device and sales information of a payment place; and the second processing device configured to perform the process of giving a point on a basis of the sales information and the giving information that are acquired from the first processing device.

### Advantageous Effects of Invention

According to the present disclosure, it is possible to achieve giving a point based on payment without requiring that a user present a card or the like for receiving a point service.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an information processing method according to an embodiment.

FIG. 2 is a flowchart illustrating a first example of the process related to the information processing method according to the embodiment.

FIG. 3 is a flowchart illustrating a second example of the process related to the information processing method according to the embodiment.

FIG. 4 is a flowchart illustrating a third example of the process related to the information processing method according to the embodiment.

FIG. 5 is a flowchart illustrating a fourth example of the process related to the information processing method according to the embodiment.

FIG. 6A is an explanatory diagram illustrating an example of a process in an information processing system according to the embodiment.

FIG. 6B is an explanatory diagram illustrating an example of a process in an information processing system according to the embodiment.

FIG. 6C is an explanatory diagram illustrating an example of a process in an information processing system according to the embodiment.

FIG. 6D is an explanatory diagram illustrating an example of a process in an information processing system according to the embodiment.

FIG. 7 is a block diagram illustrating an example of a configuration of an information processing device according to the embodiment.

FIG. 8 is an explanatory diagram illustrating an example of a hardware configuration of the information processing device according to the embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Moreover, the description will be made below in the following order.
1. Information processing method according to embodiment
2. Information processing device according to embodiment
3. Program according to embodiment

### (Information Processing Method According to Embodiment)

Hereinafter, giving points using an existing point service will be first described, and then an information processing method according to the embodiment will be described. Further, hereinafter, there will be described an example where a process related to the information processing method according to the embodiment is performed by an information processing device according to the embodiment.

Herein, the existing point service and a point service according to the embodiment are, for example, a common point service in which common points are given by a plurality of business providers and an individual point service in which points peculiar to each business provider are given. Hereinafter, a provision place of a point service to which the point service is provided is also referred to as “member store”.

Further, a point according to the embodiment is data that is given to a person who uses a point service on the basis of content of payment performed at the time of purchasing a commodity or using a service and relates to an incentive for inducing the person who uses the point service to further purchase another commodity or use another service. Hereinafter, the person who uses the point service is also referred to as “user”.

The point according to the embodiment is, for example, data showing a numerical value which can be used for payment in a provision place of a point service corresponding to the point. In a case in which the point according to the embodiment is the data showing a numerical value which can be used for payment, the point according to the embodiment has, for example, a value similar to that of currency in the provision place of the point service. Note that a relationship (so-called exchange rate) between the point according to the embodiment and currency can be arbitrarily set depending on the point service.

Note that the point according to the embodiment is not limited to the data showing a numerical value which can be used for payment in the provision place of the point service. For example, the point according to the embodiment may be data related to an arbitrary incentive, such as data showing a numerical value used to determine whether or not a condition of application for presents is satisfied (e.g., a condition in which application can be performed with predetermined points or more, or the like).

The point according to the embodiment is given while being associated with a user ID indicating the user of the point service on the basis of, for example, a predetermined giving rule of each point service, such as a purchase price (or a usage price of a service), a purchased commodity (or a used service), date and time of a purchase (or date and time of usage of a service), and a purchase store (or a usage store of a service).

### [1] Giving Points Using Existing Point Service

Giving points using the existing point service will be described.

In the existing point service, points are given when a user presents a point card or the like corresponding to a point service at the time of payment in a member store related to a common point service or a member store related to an individual point service.

Herein, a purpose and advantage of using the existing point service for the user are, for example, as follows.

The user can acquire a point or the like which can be used for the next purchase by presenting a point card.

Further, purposes and advantages of providing the existing point service for a member store are, for example, as follows.

The member store can expect lock-in of users and acquisition of users by giving points.

The member store can associate a point card ID associated with user information with sales information indicating sales such as point of sale (POS) data and can therefore acquire purchase data associated with an individual.

In a case in which the member store is a member store of a common point service, the member store can obtain an analysis report from a provider who provides the common point service in some cases.

Further, purposes and advantages of providing the existing point service for a provider who provides a common point service are, for example, as follows.

The provider obtains sales information associated with a point card ID from each member store and can therefore acquire purchase data associated with an individual across the member stores.

In a case in which a point is given, the provider can obtain point capital and commission from each member store.

As described above, in a case in which the existing point service is provided and the user uses the point service, the user, the member store, and the provider who provides the common point service have respective advantages.

However, in the existing point service, no point is given unless the user presents a point card corresponding to the point service to a person who performs operation related to payment such as a salesperson at the time of payment (or on another day after payment) or the like. Further, also in a case in which a device to which the above existing technology is applied is used, similarly, no point is given unless the above presentation is performed. In other words, giving a point in the existing point service depends on presentation of the point card or the like by the user.

Herein, presentation of the point card or the like by the user is not performed for the following reasons.

The user does not notice that a member store provides a point service.

The user does not bring a point card or the like corresponding to a point service that the user does not frequently use because, for example, there is no sufficient space for point cards in his/her purse.

Only a few points are given or no point is given for payment.

The user's reason such as being in a hurry.

In other words, a case in which presentation of the point card or the like by the user is not performed is, for example, a case in which the user does not perform presentation thereof because the user does not notice, a case in which the user does not have the point card or the like, or a case in which the user intendedly present no point card or the like.

Further, in a case in which a rate of presentation of the point card or the like by the user is low, the member store and the provider who provides the common point service cannot obtain the above advantages. Therefore, a low rate of presentation of the point card or the like by the user reduces comprehensiveness of marketing data or has a bad influence on point business.

Furthermore, in order to provide the existing point service, there are the following disadvantages in, for example, a member store.

Not only payment operation but also operation related to giving a point using a point card or the like is performed, and therefore a burden on a salesperson is increased.

Addition of operation related to giving a point increases processing time in a register of the member store. Further, the increase in the processing time in the register may lead to reduction in satisfaction of customers and opportunity loss of sales.

It is necessary to make an investment in infrastructure for conducting the point service, such as reading a point card, cooperation with a POS device, and connection to a server that performs a process of giving a point.

### [2] Process Related to Information Processing Method According to Embodiment

### [2-1] Overview of Process Related to Information Processing Method According to Embodiment

As described above, giving a point in the existing point service depends on presentation of a point card or the like by a user. Further, giving a point depends on presentation of a point card or the like, and therefore, in a case in which the existing point service is used, the point service is not provided unless the point card or the like is presented to a person who performs operation related to payment such as a salesperson.

In view of this, the information processing device according to the embodiment simulatively achieves presentation of a point card or the like by a user on the basis of payment, thereby achieving a point service that does not depend on presentation of the point card or the like by the user.

Herein, although giving a point based on payment in a member store is a set with payment, a process related to payment and a process related to giving a point are different processes for, for example, the following reasons,

A provider of payment means (e.g., cash, electronic money, credit card, and the like) is different from a provider of a point service.

A system that performs the process related to payment and a system that performs the process related to giving a point are different systems.

For example, in a case in which a user performs electronic payment by using electronic money, a credit card, or the like, it is possible to uniquely identify the user who has performed the payment by using an ID or the like. Therefore, it is possible to simulatively achieve presentation of a point card or the like by the user on the basis of the payment by, for example, associating an ID related to giving a point such as a point card ID with the ID related to payment.

Further, it is generally desirable to immediately perform the process related to payment at the time of payment. However, it is considered that the process related to giving a point does not need to be immediately performed at the time of payment. Therefore, the process related to giving a point is less restricted in time than the process related to payment, and it is possible to perform the process more flexibly.

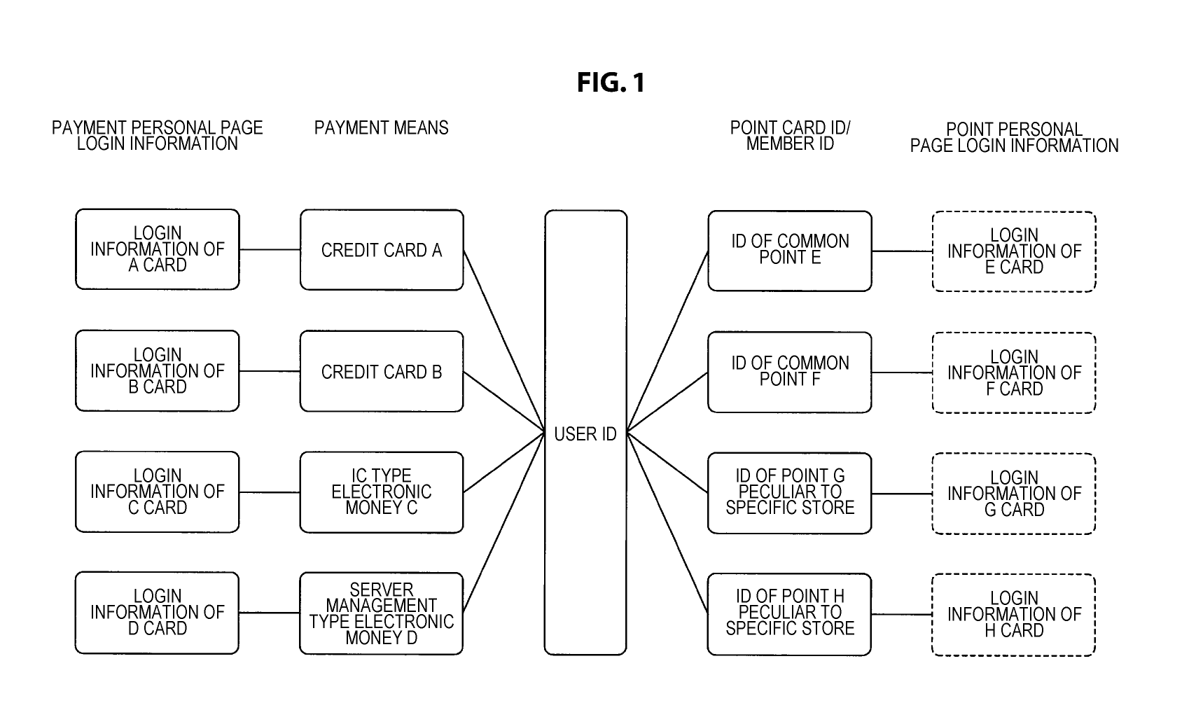

FIG. 1 is an explanatory diagram illustrating an information processing method according to the embodiment and conceptionally illustrates an example of association of a user ID related to giving a point according to the embodiment with other pieces of information. Note that a recording medium on which each piece of information illustrated in FIG. 1 is recorded may be a single recording medium or may be a plurality of different recording media.

As illustrated in FIG. 1, a user ID of a certain user is associated with, for example, information indicating a method of payment by the user (“payment means” illustrated in FIG. 1) and an ID indicating a point to be given (“point card ID or member ID” illustrated in FIG. 1). Further, the user II) of the certain user is associated with login information of a Webpage used to, for example, cause the user to grasp content of payment (“payment personal page login information” illustrated in FIG. 1). Furthermore, the user ID of the certain user may be associated with login information of a Webpage used to, for example, cause the user to grasp a state of given points (“point personal page login information” illustrated in FIG. 1).

Association of the user ID with other pieces of information illustrated in FIG. 1 is achieved by the user performing, for example, “registration operation of payment personal page login information for each electronic payment means”, “registration operation of an ID indicating a point to be given”, and the like.

Note that the ID indicating a point to be given and the point according to the embodiment are associated and managed by, for example, a table (or database) in which the ID indicating a point to be given and the point according to the embodiment are recorded while being associated with each other. Hereinafter, the table (or database) in which the ID indicating a point to be given and the point according to the embodiment are recorded while being associated with each other is also referred to as “point management table”.

For example, a processing device such as a server that performs a process of giving a point (corresponding to a second processing device according to the embodiment described below) updates the point management table on the basis of content of payment, and therefore a point according to the embodiment corresponding to the content of the payment is given to the user.

Further, the user ID may be associated with, for example, user information indicating one or two or more of name, age, sex, address, and the like of the user.

Hereinafter, the process related to the information processing method according to the embodiment will be described.

The information processing device according to the embodiment associates payment information with giving information and causes the associated payment information and giving information to be transmitted to a transmission target (point giving control process)

Herein, the payment information according to the embodiment is data including one or two or more pieces of information for specifying sales information in a payment place.

The payment information according to the embodiment is, for example, one or two or more pieces (so-called payment data) of payment time (e.g., date and time) at which payment is performed, a payment place where the payment is performed, and a price related to the payment.

Further, the payment information according to the embodiment may be, for example, purchase data related to a commodity or service, such as data related to a purchased commodity (e.g., data showing “a commodity code indicating the commodity” or “the commodity code and the number of purchased commodities”) and data related to a used service (e.g., data showing “a service code indicating the service” or “the service code and the number of people who use the service”). The above commodity code or the above service code is, for example, a Japanese article number (JAN) code, an European article number (EAN) code, or the like.

Furthermore, the payment information according to the embodiment may include both the above payment data and the above purchase data.

The information processing device according to the embodiment acquires the payment information from, for example, a device that manages electronic payment such as a server that manages payment using electronic money or a server that manages payment using a credit card. A method of acquiring the payment information from an external device such as the device that manages electronic payment is, for example, a method of acquiring the payment information from an information disclosure page of a payment service provider, a method of acquiring the payment information via communication using an application programming interface (API) or the like, or other methods. Hereinafter, there will be mainly described an example where the information processing device according to the embodiment acquires payment information from an information disclosure page.

Note that the method of acquiring payment information according to the embodiment is not limited to the above method.

For example, the information processing device according to the embodiment can also determine one or two or more pieces of information specified on the basis of receipt information as payment information.

Herein, the receipt information according to the embodiment is, for example, data showing a result of reading letters from a captured image obtained by capturing an image of a receipt made of a paper medium or the like. The receipt information according to the embodiment is, for example, text data showing the read letters (including numbers and symbols. Hereinafter, the same applies.).

The information processing device according to the embodiment extracts one or two or more pieces of information for specifying sales information in a payment place from receipt information generated on the basis of a captured image obtained by capturing an image of a receipt or receipt information generated on the basis of the captured image acquired from an external device. Herein, the information processing device according to the embodiment or the above external device reads letters from the captured image obtained by capturing the image of the receipt by using an arbitrary technology capable of detecting letters from an image, such as optical character recognition (OCR), thereby generating receipt information.

Then, the information processing device according to the embodiment determines the extracted one or two or more pieces of information as payment information.

Note that the receipt information according to the embodiment is not limited to the example described above.

For example, the receipt information according to the embodiment may be an electronic receipt generated by a POS device or the like at the time of payment. The electronic receipt according to the embodiment includes one or two or more pieces of data corresponding to POS data. The data corresponding to POS data is, for example, a JAN code, an EAN code, or the like.

Further, the giving information according to the embodiment is data used to give points. The giving information according to the embodiment is, for example, an ID indicating a point to be given such as the “point card ID or member ID” illustrated in FIG. 1. Note that the giving information according to the embodiment is not limited to the ID and may be data of an arbitrary format which is capable of specifying a point to he given.

Further, the transmission target according to the embodiment is a “target device to which the information processing device according to the embodiment transmits associated payment information and giving information”. The transmission target according to the embodiment is, for example, a first processing device according to the embodiment or the second processing device according to the embodiment. One or both of the first processing device according to the embodiment and the second processing device according to the embodiment form an information processing system according to the embodiment including the information processing device according to the embodiment.

The first processing device according to the embodiment is, for example, a device having a function of managing sales information in a payment place such as a store. The sales information according to the embodiment is, for example, POS data.

The first processing device according to the embodiment is, for example, a POS device, a server connected to the POS device (hereinafter, also referred to as “POS server”), or the like. Further, the first processing device can have, for example, a hardware configuration similar to that of the information processing device according to the embodiment described below.

In a case in which the first processing device is a transmission target, the first processing device causes the second processing device to perform a process of giving a point on the basis of payment information and giving information acquired from the information processing device according to the embodiment and sales information in a payment place. The first processing device transmits, to the second processing device, for example, a point giving request including the giving information, the sales information in the payment place, and a processing instruction to cause the second processing device to perform a process of giving a point, thereby causing the second processing device to perform the process of giving a point.

The second processing device according to the embodiment is, for example, a device having a function of performing a process of giving a point.

The second processing device is, for example, a server that a provider who provides a point service uses to provide the point service, or the like. Further, the second processing device can have, for example, a hardware configuration similar to that of the information processing device according to the embodiment described below.

In a case in which the second processing device is a transmission target, the second processing device performs a process of giving a point on the basis of payment information and giving information acquired from the information processing device according to the embodiment and sales information in a payment place. Herein, the case in which the second processing device is a transmission target is, for example, a case in which the second processing device can specify sales information in a payment place, regardless of whether or not the user presents a point card or the like.

Further, in a case in which the second processing device is not a transmission target, the second processing device performs a process of giving a point on the basis of the above point giving request acquired from the first processing device. In a case in which, for example, the second processing device acquires the above point giving request from the first processing device, the second processing device performs a process of giving a point on the basis of the giving information and the sales information in the payment place included in the above point giving request.

The information processing device according to the embodiment causes associated payment information and giving information to be transmitted to one of the first processing device and the second processing device serving as a transmission target.

As described above, the information processing device according to the embodiment performs the “point giving control process of associating payment information with giving information and causing the associated payment information and giving information to be transmitted to a transmission target” as the process related to the information processing method according to the embodiment.

The information processing device according to the embodiment transmits the associated payment information and giving information to the transmission target, thereby causing the second processing device such as a server that a provider who provides a point service uses to provide the point service to perform a process of giving a point.

Therefore, because the information processing device according to the embodiment performs the point giving control process related to the information processing method according to the embodiment, it is possible to achieve giving a point based on payment without requiring that the user present a card or the like for receiving a point service.

Note that the above point giving control process is separated from the process related to the information processing method according to the embodiment for convenience sake. Therefore, in the process related to the information processing method according to the embodiment, the above point giving control process can also be grasped as, for example, two or more of processes (by an arbitrary separating method).

### [2-2] Examples of Process Related to Information Processing Method According to Embodiment

Next, the point giving control process related to the information processing method according to the embodiment will be described more specifically. Further, hereinafter, the point giving control process is divided into two processes: (1) an association process of associating payment information with giving information; and (2) a transmission process of causing the associated payment information and giving information to be transmitted to a transmission target, and the two processes will be described.

### (1) Association Process

The information processing device according to the embodiment specifies giving information to be associated with payment information on the basis of the payment information.

Herein, the information processing device according to the embodiment specifies giving information to be associated with payment information on the basis of, for example, “a table (or database) in which content of payment (corresponding to content indicated by one or two or more pieces of information included in the payment information) is associated with one or two or more pieces of giving information” and the payment information. The information processing device according to the embodiment specifies giving information to be associated with payment information by referring to the above table stored on, for example, a storage unit (described below) included in the information processing device according to the embodiment or a recording medium outside the information processing device according to the embodiment.

Further, the information processing device according to the embodiment can also cause, for example, a transmission request including payment information and a processing instruction to transmit giving information corresponding to the payment information to be transmitted to an external device, thereby specifying giving information acquired from the external device as giving information to be associated with the payment information. The external device serving as a target to which the above transmission request is transmitted is, for example, a device that manages sales information in a payment place corresponding to payment information (e.g., a POS device, a server, or the like) or a device that a provider who provides a point service uses to provide the point service (e.g., a server or the like).

More specifically, the information processing device according to the embodiment specifies giving information to be associated with payment information by, for example, performing any one of an association process according to a first example in (1-1) described below to an association process according to a third example in (1-3) described below.

### (1-1) First Example of Association Process

In a case in which giving information obtained by referring to the above table or giving information acquired from an external device is a single piece of information, the information processing device according to the embodiment determines the giving information as giving information to be associated with payment information.

Note that, for example, in a case in which a single store conducts a plurality of point services or other cases, the giving information obtained by referring to the above table or the giving information acquired from the external device is not limited to a single piece of information. As described above, in a case in which a plurality of pieces of giving information obtained by referring to the above table or a plurality of pieces of giving information acquired from the external device exist, i.e., in a case in which a plurality of pieces of giving information that can be associated with the payment information exist, the information processing device according to the embodiment performs an association process according to a second example in (1-2) described below or the association process according to the third example in (1-3) described below.

### (1-2) Second Example of Association Process

In a case in which a plurality of pieces of giving information that can be associated with payment information exist, the information processing device according to the embodiment specifies giving information to be associated with the payment information on the basis of the payment information and setting information for specifying giving information.

Herein, the following are examples (A) to (D) of the association process based on the setting information.

(A) First Example of Association Process based on Setting Information

A priority of a point to be given is set in the setting information. In the setting information according to the first example, for example, an ID related to giving a point such as the “point card ID/member ID” illustrated in FIG. 1 and data showing a priority are recorded while being associated with each other.

For example, the information processing device according to the embodiment specifies, as giving information to be associated with payment information, giving information used to give a point having a higher priority among a plurality of pieces of giving information that can be associated with the payment information.

(B) Second Example of Association Process based on Setting Information

A priority of a point to be given in each payment place is set in the setting information. In the setting information according to the second example, for example, information indicating a payment place (e.g., an ID indicating a store, or the like) and data showing a priority are recorded while being associated with each other.

For example, the information processing device according to the embodiment specifies, as giving information to be associated with payment information, giving information used to give a point having a higher priority in a payment place indicated by the payment information among a plurality of pieces of giving information that can be associated with the payment information.

(C) Third Example of Association Process based on Setting Information

A priority of a point to be given for each payment method is set in the setting information. The payment method is, for example, payment using electronic money or payment using a credit card as in “payment means” illustrated in FIG. 1. In the setting information according to the third example, for example, an ID indicating a payment method and data showing a priority are recorded while being associated with each other.

For example, the information processing device according to the embodiment specifies, as giving information to be associated with payment information, giving information used to give a point having a higher priority in a payment method indicated by the payment information among a plurality of pieces of giving information that can be associated with the payment information.

(D) Fourth Example of Association Process based on Setting Information

A rate of earning points to be given on the basis of content of payment is set is set in the setting information. In the setting information according to the fourth example, for example, an ID related to giving a point such as the “point card ID/member ID” illustrated in FIG. 1 and data showing the earning rate are recorded while being associated with each other.

For example, the information processing device according to the embodiment specifies, as giving information to be associated with payment information, giving information used to give a point having a higher earning rate based on content of payment indicated by the payment information among a plurality of pieces of giving information that can be associated with the payment information.

For example, as in (A) to (D) described above, the information processing device according to the embodiment uses setting information in which a priority of a point to be given or a rate of earning points to be given is set, thereby specifying giving information to be associated with payment information among a plurality of pieces of giving information that can be associated with the payment information.

Note that a method of specifying giving information to be associated with payment information among a plurality of pieces of giving information that can be associated with the payment information is not limited to the methods based on setting information in (A) to (D) described above. For example, the information processing device according to the embodiment can specify giving information to be associated with payment information among a plurality of pieces of giving information that can be associated with the payment information by using setting information indicating an arbitrary index capable of specifying a single piece of giving information.

### (1-3) Third Example of Association Process

In a case in which a plurality of pieces of giving information that can be associated with payment information exist, the information processing device according to the embodiment specifies giving information to be associated with the payment information on the basis of a state related to a point.

Herein, the following are examples (a) to (c) of the association process based on the state related to a point.

(a) First Example of Association Process based on State Related to a Point

A state related to a point according to a first example is a state of given points. The state of given points is specified by, for example, checking points associated with an ID related to giving a point such as the “point card ID/member ID” associated with the user ID illustrated in FIG. 1.

For example, the information processing device according to the embodiment specifies, as giving information to be associated with payment information, giving information used to give a point having more points that have already been given among a plurality of pieces of giving information that can be associated with the payment information. The information processing device according to the embodiment specifies, for example, giving information used to give a point having more specified points as giving information to be associated with the payment information.

In a case in which the association process based on a state related to a point according to the first example is performed, a point that is larger in amount among points that have already been given to the user is given on the basis of payment.

(b) Second Example of Association Process based on State Related to a Point

A state related to a point according to a second example is a usage state of points. The usage state of points is specified by, for example, checking a usage history of points associated with an ID related to giving a point such as the “point card ID/member ID” associated with the user ID illustrated in FIG. 1.

For example, the information processing device according to the embodiment specifies, as giving information to be associated with payment information, giving information used to give a point of points having a higher usage frequency among a plurality of pieces of giving information that can be associated with the payment information.

Further, for example, the information processing device according to the embodiment can also specify, as giving information to be associated with payment information, giving information used to give a same type of a point as a point that has been used more recently among a plurality of pieces of giving information that can be associated with the payment information.

In a case in which the association process based on a state related to a point according to the second example is performed, a same type of a point as a point having a higher usage frequency among possessed points or a point that has been used recently is given on the basis of payment.

(c) Third Example of Association Process based on State Related to a Point

A state related to a point according to a third example is a state of expiration date of points. The state of an expiration date of points is specified by, for example, checking an expiration date of points associated with an ID related to giving a point such as the “point card ID/member ID” associated with the user ID illustrated in FIG. 1.

For example, the information processing device according to the embodiment specifies, as giving information to be associated with payment information, giving information used to give a point of points that have already been given and whose expiration date is closer among a plurality of pieces of giving information that can be associated with the payment information.

Further, for example, the information processing device according to the embodiment may specify, as giving information to be associated with payment information, giving information used to give a point whose expiration date is further away among a plurality of pieces of giving information that can be associated with the payment information.

In a case in which the association process based on a state related to a point according to the third example is performed, a point whose expiration date is closer among possessed points or a point whose expiration date is further away is given on the basis of payment.

For example, as in (a) to (c) described above, the information processing device according to the embodiment specifies giving information to be associated with payment information among a plurality of pieces of giving information that can be associated with the payment information on the basis of a state related to a point.

Note that a method of specifying giving information to be associated with payment information among a plurality of pieces of giving information that can be associated with the payment information is not limited to the methods based on a state related to a point in (a) to (c) described above. For example, the information processing device according to the embodiment can also specify giving information to be associated with payment information by using an index obtained by combining two or more of the states related to points in (a) to (c) described above.

### (2) Transmission Process

The information processing device according to the embodiment causes the payment information and giving information associated by the above process (1) (association process) to be transmitted to a transmission target.

The information processing device according to the embodiment causes, for example, a communication unit (described below) included in the information processing device according to the embodiment or an external communication device connected to the information processing device according to the embodiment to transmit the associated payment information and giving information to a transmission target.

Herein, the information processing device according to the embodiment causes the associated payment information and giving information to be transmitted to a transmission target set in advance. Note that the set transmission target may be changeable by a manager or the like of the information processing device according to the embodiment performing operation or the like.

Further, the information processing device according to the embodiment may cause the associated payment information and giving information to be transmitted to a transmission target determined on the basis of the payment information.

Specifically, the information processing device according to the embodiment determines, as the transmission target, for example, the second processing device capable of giving a point corresponding to giving information specified by the above process (1) (association process) or the first processing device capable of causing a point corresponding to the specified giving information to be given. Then, the information processing device according to the embodiment transmits the associated payment information and giving information to the determined transmission target.

The information processing device according to the embodiment performs, for example, the above process (1) (association process) and the above process (2) (transmission process) as the point giving control process according to the embodiment.

Note that the above process (1) (association process) and the above process (2) (transmission process) are obtained by dividing the point giving control process according to the embodiment for convenience sake. In other words, the point giving control process according to the embodiment may be a single process or may be a plurality of processes divided differently from the above process.

### [2-3] Specific Examples of Process Related to Information Processing Method According to Embodiment

Next, specific examples of the process related to the information processing method according to the embodiment will be described.

Hereinafter, as the specific examples of the process related to the information processing method according to the embodiment, examples of the process in four cases where possessors or possessing places possessing POS data (an example of sales information) are different will be described.

Herein, the following are examples (i) to (v) of the possessors or possessing places possessing POS data according to the embodiment.

(i) A retailer (who always possesses POS data, regardless of a payment method)

(ii) A provider who provides a point service (who possesses only POS data obtained in payment in which a point card or the like is presented)

(iii) A provider who provides a point service (who possesses POS data of all payments in member stores)

(iv) Secure receipt information that is improbably falsified (e.g., an electronic receipt generated by a POS device or the like and stored in a secure region of a recording medium, or the like)

(v) Insecure receipt information that may be falsified (e.g., receipt information generated on the basis of a captured image obtained by capturing an image of a receipt made of a paper medium, receipt information acquired from an external device via an email or the like, receipt information stored in an insecure region of a recording medium, or the like)

### [2-3-1] First Example of Process Related to Information Processing Method According to Embodiment

As a first example of the process related to the information processing method according to the embodiment, an example of a process where a possessor or possessing place possessing POS data is the above case (i) or the above case (ii) will be described.

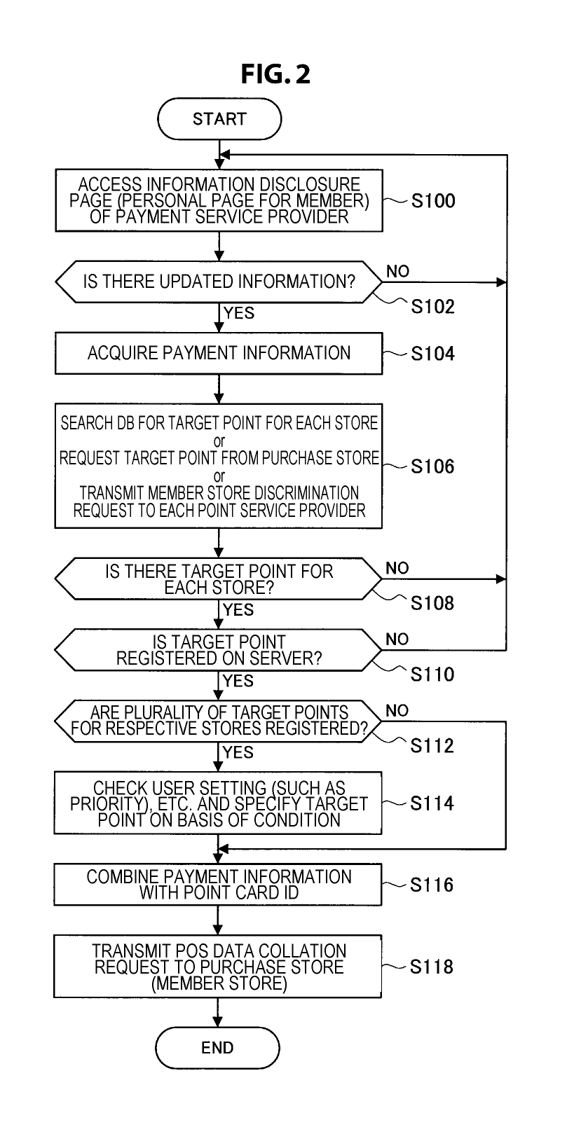

FIG. 2 is a flowchart illustrating the first example of the process related to the information processing method according to the embodiment.

The information processing device according to the embodiment accesses an information disclosure page of a payment service provider (e.g., a personal page for a member of the payment service provider) (S100). The information processing device according to the embodiment performs the process in Step S100 by using, for example, the “payment personal page login information” associated with the user ID illustrated in FIG. 1.

The information processing device according to the embodiment determines whether or not there is updated information (S102).

In a case in which it is not determined that there is updated information in Step S102, the information processing device according to the embodiment repeats the process in Step S100. The information processing device according to the embodiment, for example, regularly or irregularly repeats the process in Step S100.

Further, in a case in which it is determined that there is updated information in Step S102, the information processing device according to the embodiment acquires payment information corresponding to the updated information (S104). The information processing device according to the embodiment acquires payment information from, for example, the information disclosure page of the payment service provider.

As described above, the payment information can include a payment place such as a store. Further, content of payment such as a payment place is reflected in the information disclosure page by, for example, a device corresponding to the payment service provider such as a “credit/electronic money server” as described below.

Herein, a method of writing the payment place such as a store reflected in the information disclosure page is expected to be different for each payment service provider in some cases. When the payment place reflected in the information disclosure page is differently written for each payment service provider and the information processing device according to the embodiment acquires the payment place reflected in the information disclosure page, misrecognition of the payment place as in the following example may occur.

Payments actually performed in the same store (an example of the payment place) are recognized as payments performed in different stores.

Note that the above misrecognition that is caused because writing is different for each payment service provider is not limited to a case in which a method of writing a payment place is different for each payment service provider. For example, the misrecognition that is caused because writing is different for each payment service provider may also occur in a case in which a method of writing one or both of payment time such as date and time of payment and a price related to payment is different for each payment service provider.

In view of this, in a case in which payment information is acquired from the information disclosure page, the information processing device according to the embodiment may normalize content of payment reflected in the information disclosure page so that the content of payment can be uniquely identified, regardless of a payment service provider. Normalizing the content of the payment to ensure uniqueness of the content of the payment is also useful for, for example, various business providers who use the content of the payment such as a point business provider and a business provider who makes a payment inquiry such as a retailer.

The information processing device according to the embodiment normalizes the content of the payment reflected in the information disclosure page as in, for example, the following examples described in (I) to (III), thereby acquiring payment information from the information disclosure page.

### (I) First Example of Method of Normalizing Content of Payment

The information processing device according to the embodiment normalizes content of payment reflected in the information disclosure page by using, for example, a first correspondence table capable of specifying writing of each payment service provider. Herein, an example of the first correspondence table is, for example, a table (or database) in which an example of correspondence between writing by a payment service provider and a store, a chain (business provider), or the like specified on the basis of the writing is recorded.

The first correspondence table is stored for each payment service provider on, for example, a recording medium such as a storage unit (described below). Then, for example, the information processing device according to the embodiment reads out the first correspondence table from the above recording medium, thereby normalizing the content of the payment reflected in the information disclosure page.

The first correspondence table may be generated by the information processing device according to the embodiment or may be acquired from an external device such as the device corresponding to the payment service provider. In a case in which the first correspondence table is acquired from the external device, the information processing device according to the embodiment and the payment service provider or the like corresponding to the external device share the first correspondence table.

(II) Second Example of method of Normalizing Content of Payment

For example, in a case in which the device corresponding to the payment service provider reflects an identifier capable of specifying a store as content of payment, the information processing device according to the embodiment normalizes a payment place (an example of the content of the payment) reflected in the information disclosure page by using the identifier.

The identifier according to the embodiment is, for example, an ID for managing a member store possessed by the payment service provider, a telephone number of a store which is opened to the public, or the like. In a case in which the identifier is the telephone number of the store which is opened to the public, it is considered that reflection of the identifier in the information disclosure page causes only a small discomfort for a user who views the information disclosure page and is also useful for the user who views the information disclosure page.

For example, in a case in which the device corresponding to the payment service provider reflects an ID for managing a member store possessed by the payment service provider as the content of the payment, the information processing device according to the embodiment normalizes a payment place (an example of the content of the payment) reflected in the information disclosure page by using the ID for managing a member store. More specifically, the information processing device according to the embodiment normalizes the payment place reflected in the information disclosure page by using, for example, a second correspondence table in which the ID for managing a member store is associated with the payment place. Herein, an example of the second correspondence table is, for example, a table (or database) in which the ID for managing a member store and a store, a chain (business provider), or the like are recorded while being associated with each other.

The second correspondence table is stored for, for example, each payment service provider on a recording medium such as a storage unit (described below). Then, for example, the information processing device according to the embodiment reads out the second correspondence table from the above recording medium, thereby normalizing the payment place reflected in the information disclosure page. The second correspondence table is acquired from, for example, an external device such as the device corresponding to the payment service provider.

Further, for example, in a case in which the device corresponding to the payment service provider reflects a telephone number of a store which is opened to the public as the content of the payment, the information processing device according to the embodiment normalizes a payment place (an example of the content of the payment) reflected in the information disclosure page by using the telephone number of the store. More specifically, the telephone number of the store read from the information disclosure page is opened to the public, and therefore the information processing device according to the embodiment specifies, for example, which telephone number of a store the acquired telephone number corresponds to by an arbitrary method such as a search via the Internet, thereby normalizing the payment place reflected in the information disclosure page.

In a case in which the normalization method according to the second example is used and the information processing device can acquire, for example, an identifier such as an ID for managing a member store from the information disclosure page, the information processing device according to the embodiment can recognize an accurate payment place where payment has actually been performed. Further, in a case in which the normalization method according to the second example is used, the information processing device according to the embodiment does not need to read, for example, a payment place such as a written name of a store from the information disclosure page.

### (III) Third Example of Method of Normalizing Content of Payment

The information processing device according to the embodiment can also normalize content of payment reflected in the information disclosure page by using both the normalization method according to the first example in (I) described above and the normalization method according to the second example in (II) described above. As an example, the information processing device according to the embodiment normalizes a payment place reflected in the information disclosure page by using the normalization method according to the second example in (II) described above and normalizes an item other than the payment place reflected in the information disclosure page by using the normalization method according to the first example in (I) described above.

Note that, as described above, a method of acquiring payment information from an external device is not limited to the method of acquiring payment information from an information disclosure page of a payment service provider. For example, the information processing device according to the embodiment can also acquire payment information from the external device by performing communication using an API or the like with an external device such as a server corresponding to the payment service provider (e.g., a server that manages payment using electronic money, a server that manages payment using a credit card, or the like).

In a case in which payment information is acquired from the external device, the information processing device according to the embodiment performs communication with the external device instead of the process in Step S100 illustrated in FIG. 1.

In a case in which the payment information is acquired in Step S104, the information processing device according to the embodiment acquires a target point for each store (S106). The information processing device according to the embodiment acquires a target point for each store by, for example, conducting a search of a database, requesting a target point for each store from a POS device or the like in a store where payment has been performed, or transmitting a member store discrimination request of a store where payment has been performed to a server of each point service provider who provides a point service.

When the process in Step S106 is performed, the information processing device according to the embodiment determines whether or not there is a target point for each store (S108). Herein, the process in Step S108 corresponds to a process of determining whether or not the store where payment has been performed corresponds to a member store who provides the point service.

In a case in which it is not determined that there is a target point for each store in Step S108, the information processing device according to the embodiment repeats the processes in and subsequent to Step S100. The information processing device according to the embodiment, for example, regularly or irregularly repeats the processes in and subsequent to Step S100.

Further, in a case in which it is determined that there is a target point for each store in Step S108, the information processing device according to the embodiment determines whether or not the target point for each store is registered (S110). The information processing device according to the embodiment performs the process in Step S110 by, for example, checking an ID related to giving a point such as the “point card ID/member ID” associated with the user ID illustrated in FIG. 1. Herein, the process in Step S110 corresponds to a process of determining whether or not a user who has performed payment receives provision of a point service corresponding to the target point for each store. Further, the process in Step S110 corresponds to a process of determining whether or not giving information that can be associated with the payment information exists.

In a case in which it is not determined that the target point for each store is registered in Step S110, the information processing device according to the embodiment repeats the processes in and subsequent to Step S100. The information processing device according to the embodiment, for example, regularly or irregularly repeats the processes in and subsequent to Step S100.

Further, in a case in which it is determined that the target point for each store is registered in Step S110, the information processing device according to the embodiment determines whether or not a plurality of target points for respective stores are registered (S112). Herein, the process in Step S112 corresponds to a process of determining whether or not a plurality of pieces of giving information that can be associated with the payment information exist.

In a case in which it is not determined that a plurality of target points for respective stores are registered in Step S112, the information processing device according to the embodiment performs a process in Step S116 described below.

Further, in a case in which it is determined that a plurality of target points for respective stores are registered in Step S112, the information processing device according to the embodiment checks, for example, a user setting or the like and specifies a target point on the basis of a condition (S114). The information processing device according to the embodiment specifies a target point by performing, for example, the association process according to the second example in (1-2) described above or the association process according to the third example (1-3) described above.

In a case in which it is not determined that a plurality of target points for respective stores are registered in Step S112 or in a case in which the process in Step S114 is performed, the information processing device according to the embodiment combines the payment information with a point card ID (an example of the giving information) corresponding to the specified point (S116). For example, the information processing device according to the embodiment performs the process in Step S116 by an arbitrary combination method such as generating data in which the payment information and the point card ID are compressed, recording the point card ID as metadata of the payment information, or the like. Herein, the process in Step S116 corresponds to an example of a process of associating payment information with giving information.

When the process in Step S116 is performed, the information processing device according to the embodiment transmits, for example, a POS data collation request including the combined payment information and point card ID and a processing instruction to a POS device or the like (an example of the first processing device) in a member store (S118).

The information processing device according to the embodiment performs, for example, the process in FIG. 2 and can therefore transmit the associated payment information and point card ID (an example of the giving information) to the POS device or the like in the member store corresponding to the first processing device.

Note that it is regardless to say that an example of the process where a possessor or possessing place possessing POS data is the above case (i) or the above case (ii) is not limited to the example illustrated in FIG. 2.

In a case in which the process according to the first example illustrated in FIG. 2 is performed, the POS device or the like (an example of the first processing device) in the member store which has received the POS data collation request transmitted from the information processing device according to the embodiment determines, for example, whether or not there is POS data corresponding to the payment information included in the POS data collation request. Further, in a case in which it is determined that there is POS data corresponding to the payment information, the POS device or the like in the member store transmits, for example, a point giving determination request including the combined payment information and point card ID and a processing instruction to a server or the like (an example of the second processing device) of a point service provider. Then, in the server or the like of the point service provider, for example, a process of giving a point is performed on the basis of the received point giving determination request.

[2-3-2] Second Example of Process Related to Information Processing method According to Embodiment

As a second example of the process related to the information processing method according to the embodiment, an example of a process where a possessor or possessing place possessing POS data is the above case (iii) will be described.

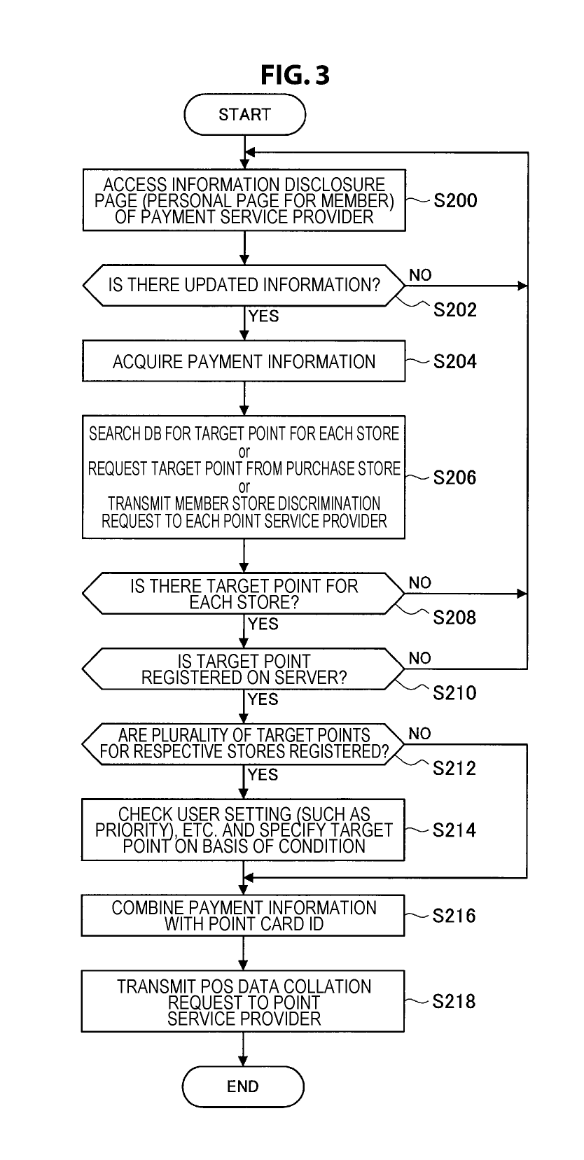

FIG. 3 is a flowchart illustrating the second example of the process related to the information processing method according to the embodiment.

The information processing device according to the embodiment accesses an information disclosure page of a payment service provider (e.g., a personal page for a member of the payment service provider) in a similar way to Step S100 of FIG. 2 (S200).

The information processing device according to the embodiment determines whether or not there is updated information (S202).

In a case in which it is not determined that there is updated information in Step S202, the information processing device according to the embodiment repeats the process in Step S200. The information processing device according to the embodiment, for example, regularly or irregularly repeats the process in Step S200.

Further, in a case in which it is determined that there is updated information in Step S202, the information processing device according to the embodiment acquires payment information corresponding to the updated information in a similar way to Step S104 of FIG. 2 (S204). Note that, as described above, the information processing device according to the embodiment can also acquire payment information from an external device by performing communication using an API or the like with the external device.

In a case in which the payment information is acquired in Step S204, the information processing device according to the embodiment acquires a target point for each store in a similar way to Step S106 of FIG. 2 (S206).

When the process in Step S206 is performed, the information processing device according to the embodiment determines whether or not there is a target point for each store in a similar way to Step S106 of FIG. 2 (S208).

In a case in which it is not determined that there is the target point for each store in Step S208, the information processing device according to the embodiment repeats the processes in and subsequent to Step S100. The information processing device according to the embodiment, for example, regularly or irregularly repeats the processes in and subsequent to Step S200.

Further, in a case in which it is determined that there is a target point for each store in Step S208, the information processing device according to the embodiment determines whether or not the target point for each store is registered in a similar way to Step S110 of FIG. 2 (S210),

In a case in which it is not determined that the target point for each store is registered in Step S210, the information processing device according to the embodiment repeats the processes in and subsequent to Step S200. The information processing device according to the embodiment, for example, regularly or irregularly repeats the processes in and subsequent to Step S200.

Further, in a case in which it is determined that the target point for each store is registered in Step S210, the information processing device according to the embodiment determines whether or not a plurality of target points for respective stores are registered in a similar way to Step S112 of FIG. 2 (S212).

In a case in which it is not determined that a plurality of target points for respective stores are registered in Step S212, the information processing device according to the embodiment performs a process in Step S216 described below

Further, in a case in which it is determined that a plurality of target points for respective stores are registered in Step S212, the information processing device according to the embodiment checks, for example, a user setting or the like and specifies a target point on the basis of a condition in a similar way to Step S114 of FIG. 2 (S214).

In a case in which it is not determined that a plurality of target points for respective stores are registered in Step S212 or in a case in which the process in Step S214 is performed, the information processing device according to the embodiment combines the payment information with a point card ID (an example of the giving information) corresponding to the specified point in a similar way to Step S116 of FIG. 2 (S216).

When the process in Step S216 is performed, the information processing device according to the embodiment transmits, for example, a POS data collation request including the combined payment information and point card ID and a processing instruction to a server or the like (an example of the second processing device) in a point service provider (S218).

The information processing device according to the embodiment performs, for example, the process in FIG. 3 and can therefore transmit the associated payment information and point card ID (an example of the giving information) to the server or the like in the point service provider corresponding to the second processing device.

Note that it is regardless to say that an example of the process where a possessor or possessing place possessing POS data is the above case (iii) is not limited to the example illustrated in FIG. 3.

In a case in which the process according to the second example illustrated in FIG. 3 is performed, a server or the like (an example of the second processing device) of a point service provider who has received the POS data collation request transmitted from the information processing device according to the embodiment determines, for example, whether or not there is POS data corresponding to the payment information included in the POS data collation request. Further, in a case in which it is determined that there is POS data corresponding to the payment information, for example, a process of giving a point is performed in the server or the like of the point service provider. In other words, for example, the POS data collation request transmitted in Step S218 of FIG. 3 can play a role of, for example, a point giving determination request serving as a trigger that causes the server or the like of the point service provider to perform the process of giving a point.

### [2-3-3] Third Example of Process Related to Information Processing Method According to Embodiment

As a third example of the process related to the information processing method according to the embodiment, an example of a process where a possessor or possessing place possessing POS data is the above case (iv) will be described.

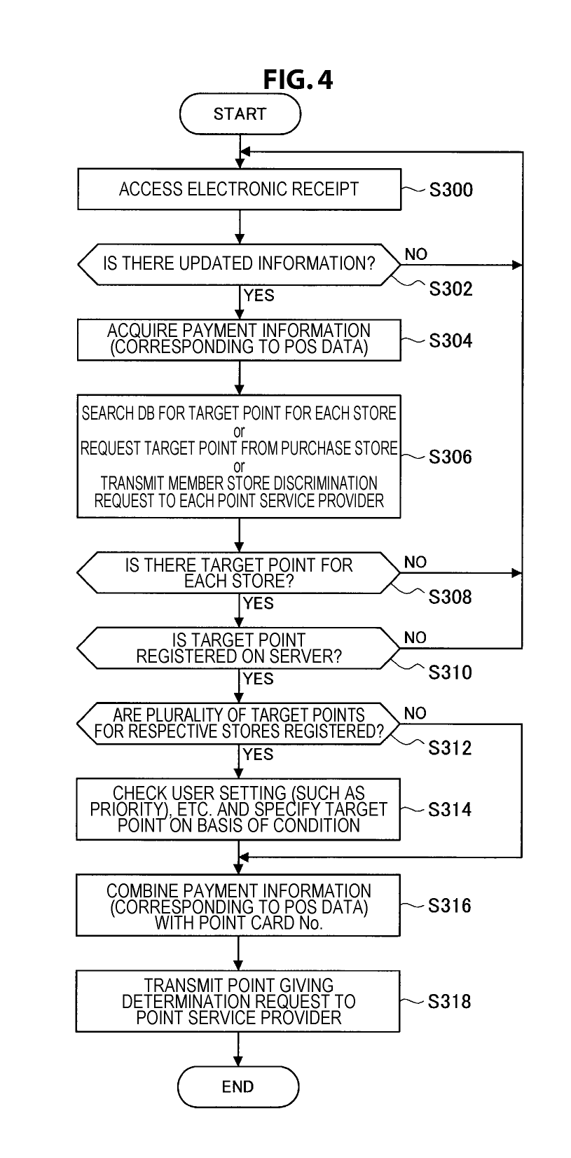

FIG. 4 is a flowchart illustrating the third example of the process related to the information processing method according to the embodiment.

The information processing device according to the embodiment accesses, for example, an electronic receipt stored in a secure region of a recording medium and reads out the electronic receipt (S300).

The information processing device according to the embodiment determines whether or not there is updated information (S302).

In a case in which it is not determined that there is updated information in Step S302, the information processing device according to the embodiment repeats the process in Step S300. The information processing device according to the embodiment, for example, regularly or irregularly repeats the process in Step S300.

Further, in a case in which it is determined that there is updated information in Step S302, the information processing device according to the embodiment acquires payment information corresponding to the updated information (S304). The information processing device according to the embodiment acquires, for example, payment information including information corresponding to POS data from the electronic receipt stored in the secure region of the recording medium.

In a case in which the payment information is acquired in Step S304, the information processing device according to the embodiment acquires a target point for each store in a similar way to Step S106 of FIG. 2 (S306).

When the process in Step S306 is performed, the information processing device according to the embodiment determines whether or not there is a target point for each store in a similar way to Step S106 of FIG. 2 (S308).

In a case in which it is not determined that there is the target point for each store in Step S308, the information processing device according to the embodiment repeats the processes in and subsequent to Step S300. The information processing device according to the embodiment, for example, regularly or irregularly repeats the processes in and subsequent to Step S300.

Further, in a case in which it is determined that there is a target point for each store in Step S308, the information processing device according to the embodiment determines whether or not the target point for each store is registered in a similar way to Step S110 of FIG. 2 (S310).

In a case in which it is not determined that the target point for each store is registered in Step S310, the information processing device according to the embodiment repeats the processes in and subsequent to Step S300. The information processing device according to the embodiment, for example, regularly or irregularly repeats the processes in and subsequent to Step S300.

Further, in a case in which it is determined that the target point for each store is registered in Step S310, the information processing device according to the embodiment determines whether or not a plurality of target points for respective stores are registered in a similar way to Step S112 of FIG. 2 (S312).

In a case in which it is not determined that a plurality of target points for respective stores are registered in Step S312, the information processing device according to the embodiment performs a process in Step S316 described below.

Further, in a case in which it is determined that a plurality of target points for respective stores are registered in Step S312, the information processing device according to the embodiment checks, for example, a user setting or the like and specifies a target point on the basis of a condition in a similar way to Step S114 of FIG. 2 (S314).

In a case in which it is not determined that a pluralizy of target points for respective stores are registered in Step S312 or in a case in which the process in Step S314 is performed, the information processing device according to the embodiment combines the payment information with a point card ID (an example of the giving information) corresponding to the specified point in a similar way to Step S116 of FIG. 2 (S316).

When the process in Step S316 is performed, the information processing device according to the embodiment transmits, for example, a point giving determination request including the combined payment information and point card ID and a processing instruction to a server or the like (an example of the second processing device) in a point service provider (S318).

The information processing device according to the embodiment performs, for example, the process in FIG. 4 and can therefore transmit the associated payment information and point card ID (an example of the giving information) to the server or the like in the point service provider corresponding to the second processing device.

Note that an example of the process where the possessor or possessing place possessing POS data is the above case (iv) is not limited to the example illustrated in FIG. 4.

For example, in a case in which the electronic receipt does not include data corresponding to the POS data, it is necessary to make an inquiry concerning accurate POS data. Therefore, in a case in which the electronic receipt does not include data corresponding to the POS data, a process similar to that of FIG. 2 or FIG. 3 is performed, and it is not necessarily utilize the electronic receipt.

However, in a case in which the electronic receipt is secure as in the above case (iv), it is possible to prove that a purchase is performed by the user himself/herself on the basis of the electronic receipt. Therefore, the process related to acquisition of payment information described in, for example, Steps S100 to S104 of FIG. 2 (or Steps S200 to S204 illustrated in FIG. 3) can be replaced with acquisition of payment information from the electronic receipt.

In a case in which the process according to the third example illustrated in FIG. 4 is performed, for example, a process of giving a point is performed on the basis of the point giving determination request in the server or the like (an example of the second processing device) of the point service provider who has received the point giving determination request transmitted from the information processing device according to the embodiment.

### [2-3-4] Fourth Example of Process Related to Information Processing Method According to Embodiment

As a fourth example of the process related to the information processing method according to the embodiment, an example of a process where a possessor or possessing place possessing POS data is the above case (iv) will be described.

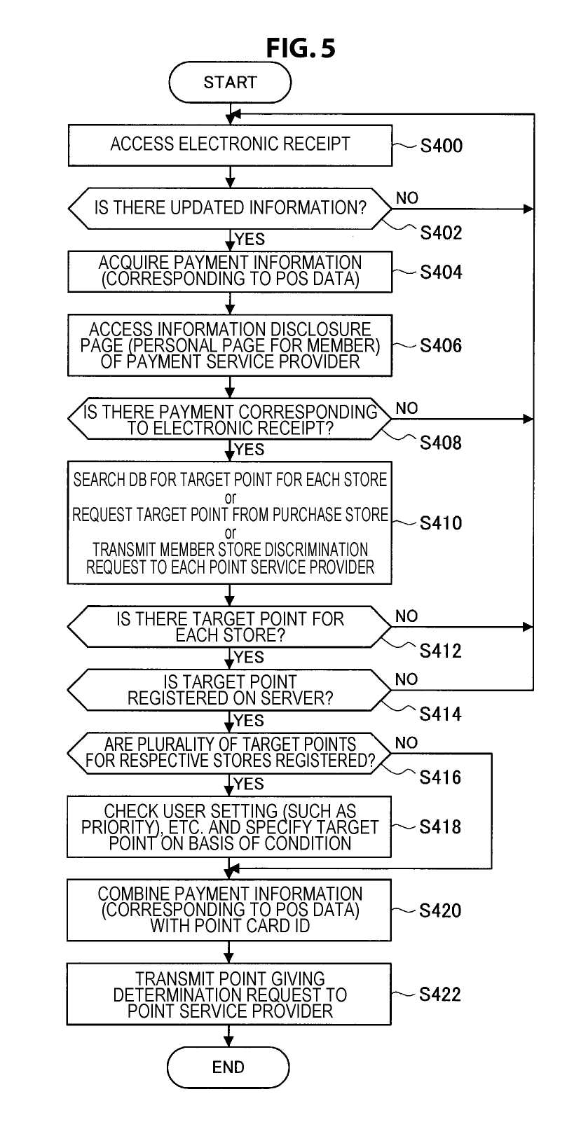

FIG. 5 is a flowchart illustrating the fourth example of the process related to the information processing method according to the embodiment.

The information processing device according to the embodiment accesses, for example, an electronic receipt stored in a recording medium and reads out the electronic receipt (S400).

The information processing device according to the embodiment determines whether or not there is updated information (S402).

In a case in which it is not determined that there is updated information in Step S402, the information processing device according to the embodiment repeats the process in Step S400. The information processing device according to the embodiment, for example, regularly or irregularly repeats the process in Step S400.

Further, in a case in which it is determined that there is updated information in Step S402, the information processing device according to the embodiment acquires payment information corresponding to the updated information (S404). The information processing device according to the embodiment acquires, for example, payment information including information corresponding to POS data from the electronic receipt stored in the recording medium.

In a case in which the payment information is acquired in Step S404, the information processing device according to the embodiment accesses an information disclosure page of a payment service provider (e.g., a personal page for a member of the payment service provider) in a similar way to Step S100 of FIG. 2 (S406).

Then, the information processing device according to the embodiment determines whether or not payment corresponding to the electronic receipt exists in the information disclosure page of the payment service provider (S408). By performing the process in Step S406, it is possible to prevent a point from being given on the basis of a falsified electronic receipt.

In a case in which it is not determined that payment corresponding to the electronic receipt exists in the information disclosure page of the payment service provider in Step S408, the information processing device according to the embodiment repeats the processes in and subsequent to Step S400. The information processing device according to the embodiment, for example, regularly or irregularly repeats the processes in and subsequent to Step S400.

Further, in a case in which it is determined that payment corresponding to the electronic receipt exists in the information disclosure page of the payment service provider in Step S408, the information processing device according to the embodiment acquires a target point for each store in a similar way to Step S106 of FIG. 2 (S410).

When the process in Step S410 is performed, the information processing device according to the embodiment determines whether or not there is a target point for each store in a similar way to Step S106 of FIG. 2 (S412).

In a case in which it is not determined that there is the target point for each store in Step S412, the information processing device according to the embodiment repeats the processes in and subsequent to Step S400. The information processing device according to the embodiment, for example, regularly or irregularly repeats the processes in and subsequent to Step S400.

Further, in a case in which it is determined that there is a target point for each store in Step S412, the information processing device according to the embodiment determines whether or not the target point for each store is registered in a similar way to Step S110 of FIG. 2 (S414).

In a case in which it is not determined that the target point for each store is registered in Step S414, the information processing device according to the embodiment repeats the processes in and subsequent to Step S400. The information processing device according to the embodiment, for example, regularly or irregularly repeats the processes in and subsequent to Step S400.

Further, in a case in which it is determined that the target point for each store is registered in Step S414, the information processing device according to the embodiment determines whether or not a plurality of target points for respective stores are registered in a similar way to Step S112 of FIG. 2 (S416).

In a case in which it is not determined that a plurality of target points for respective stores are registered in Step S416, the information processing device according to the embodiment performs a process in Step S420 described below.

Further, in a case in which it is determined that a plurality of target points for respective stores are registered in Step S416, the information processing device according to the embodiment checks, for example, a user setting or the like and specifies a target point on the basis of a condition in a similar way to Step S114 of FIG. 2 (S418).

In a case in which it is not determined that a plurality of target points for respective stores are registered in Step S416 or in a case in which the process in Step S418 is performed, the information processing device according to the embodiment combines the payment information with a point card ID (an example of the giving information) corresponding to the specified point in a similar way to Step S116 of FIG. 2 (S420).

When the process in Step S420 is performed, the information processing device according to the embodiment transmits, for example, a point giving determination request including the combined payment information and point card ID and a processing instruction to a server or the like (an example of the second processing device) in a point service provider (S422).

The information processing device according to the embodiment performs, for example, the process in FIG. 5 and can therefore transmit the associated payment information and point card ID (an example of the giving information) to the server or the like in the point service provider corresponding to the second processing device.

Note that an example of the process where the possessor or possessing place possessing POS data is the above case (iv) is not limited to the example illustrated in FIG. 5.

For example, in a case in which the electronic receipt does not include data corresponding to the POS data, it is necessary to make an inquiry concerning accurate POS data. Therefore, in a case in which the electronic receipt does not include data corresponding to the POS data, a process similar to that of FIG. 2 or FIG. 3 is performed, and it is not necessarily utilize the electronic receipt.

In a case in which the process according to the fourth example illustrated in FIG. 5 is performed, for example, a process of giving a point is performed on the basis of the point giving determination request in the server or the like (an example of the second processing device) of the point service provider who has received the point giving determination request transmitted from the information processing device according to the embodiment.

### [2-4] Example of Process in Information Processing System According to Embodiment

Next, there will be described an example of a process in the information processing system according to the embodiment including the information processing device according to the embodiment which performs the process related to the information processing method according to the embodiment.

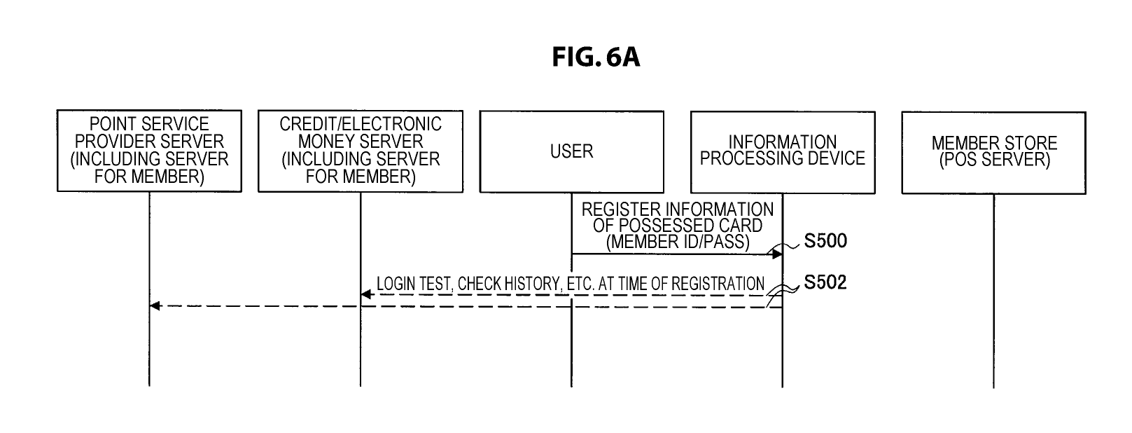

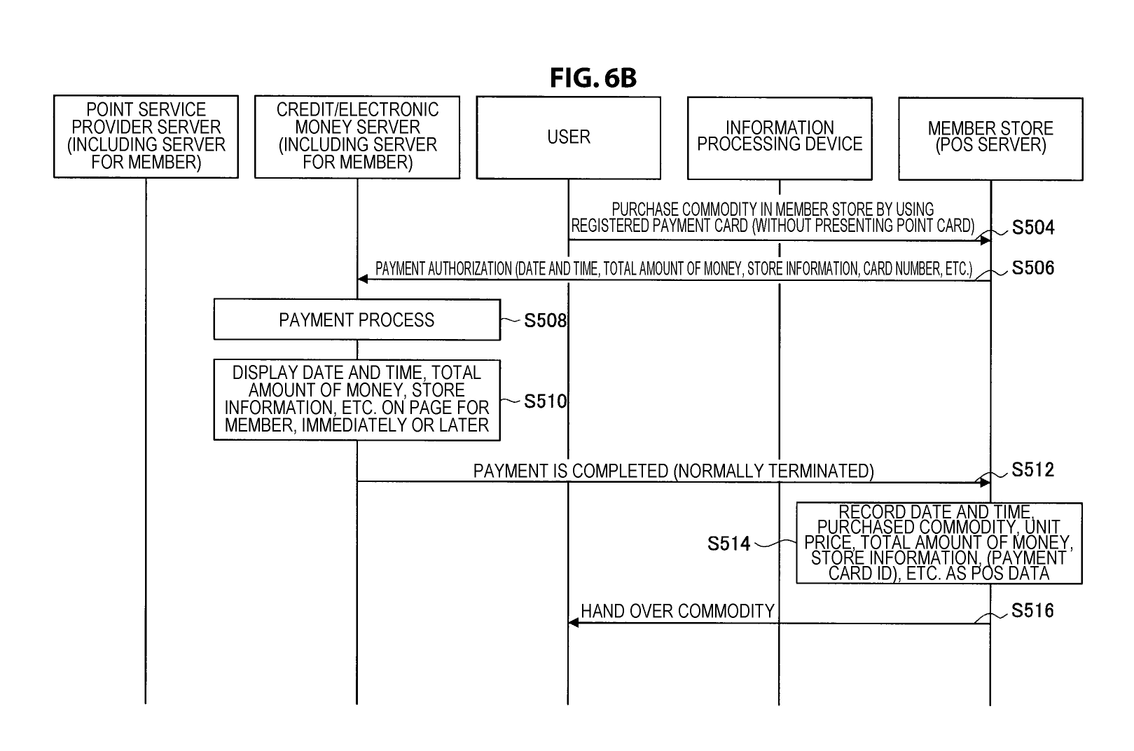

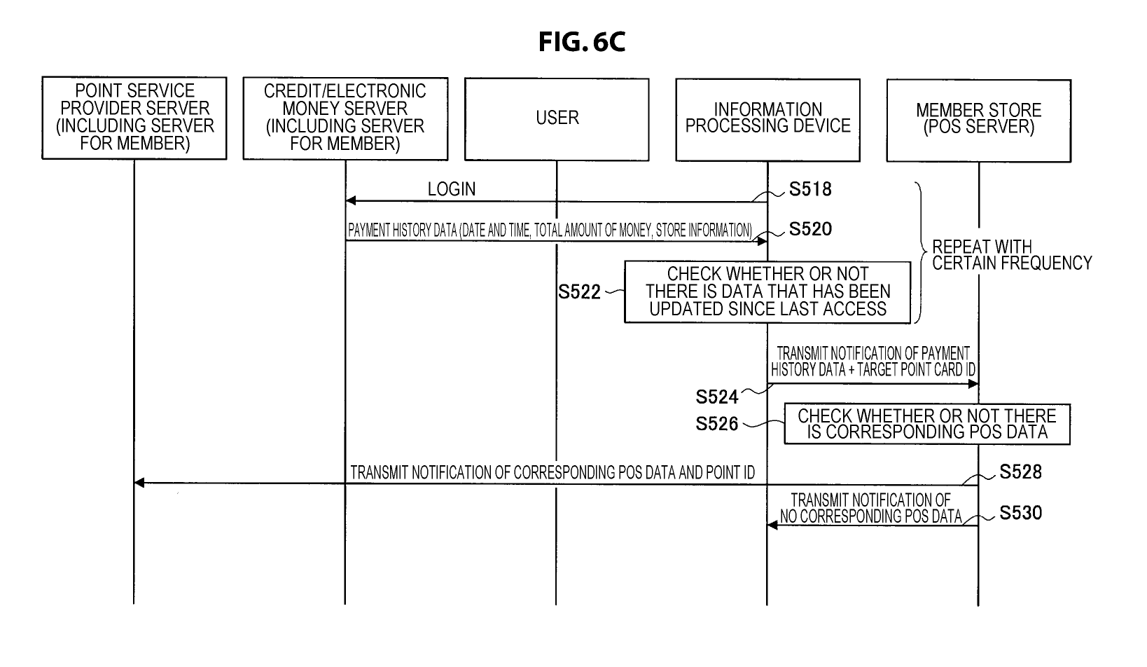

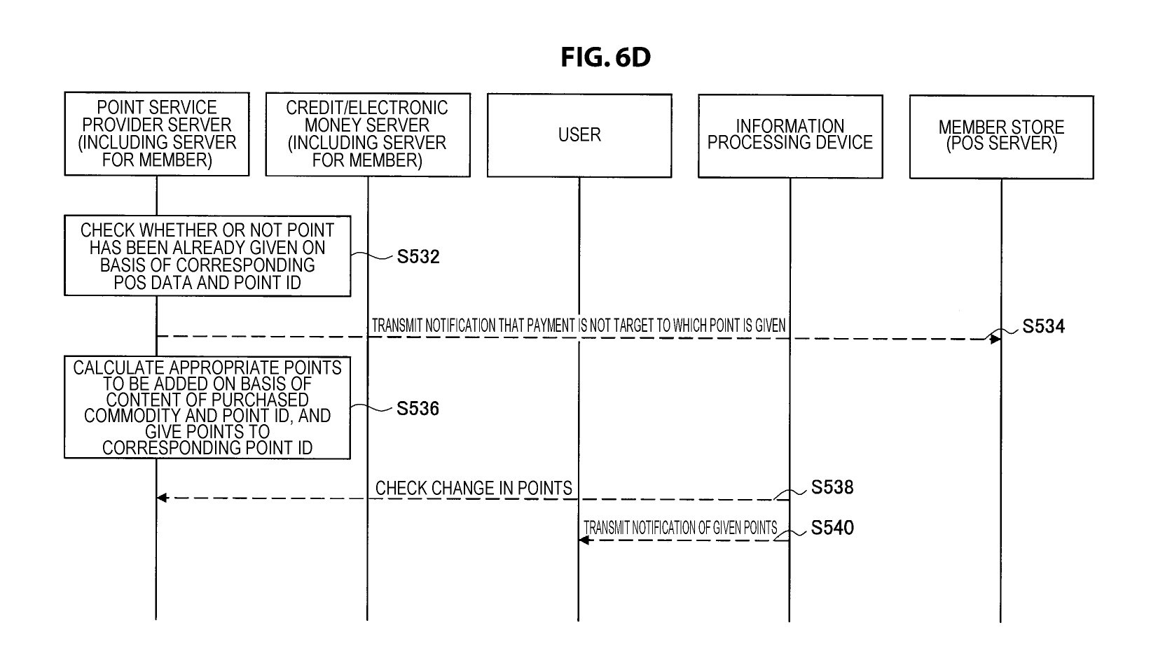

FIGS. 6A to 6B are explanatory diagrams illustrating an example of the process in the information processing system according to the embodiment.

Herein, an “information processing device” illustrated in FIGS. 6A to 6D corresponds to the information processing device according to the embodiment which performs the process related to the information processing method according to the embodiment. Further, a “member store (POS server)” illustrated in FIGS. 6A to 6D corresponds to the first processing device according to the embodiment, and a “point service provider server” illustrated in FIGS. 6A to 6D corresponds to the second processing device according to the embodiment. Further, for convenience of explanation, FIGS. 6A to 6D illustrate a user and a server of a payment service provider (“credit/electronic money server” illustrated in FIGS. 6A to 6D).

Further, the process illustrated in FIGS. 6A to 6D shows an example where a transmission target to which the information processing device according to the embodiment transmits associated payment information and giving information is the “member store (POS server)” corresponding to the first processing device.

### [2-4-1] Process Related to Advanced Registration (FIG. 6A)

The user registers information (e.g., a member ID and a password) related to a payment method such as a credit card or an electronic money card possessed by the user and information (e.g., a member ID and a password) related to a point service of a point card or the like possessed by the user on the information processing device according to the embodiment (S500). For example, the user performs registration operation on a Webpage or the like, and therefore various kinds of information are registered. Hereinafter, cards related to payment such as a credit card and an electronic money card are also collectively referred to as “payment card”.

Herein, Step S500 may be performed via, for example, an account aggregation application or the like. Further, in Step S500, the user may further perform a setting related to a priority of a point such as specification of a prioritized point, registration of a rate of earning points, and the like.

The information processing device according to the embodiment accesses the “point service provider server” and the “credit/electronic money server” by using the various kinds of information registered in Step S500 and checks a state at the time of registration (S502).

Herein, the process in Step S502 is performed to prevent spoofing and check a state at the time of registration. Note that the information processing device according to the embodiment may or may not perform the process in Step S502.

### [2-4-2] Process Related to Payment (FIG. 6B)

When the user purchases a commodity in the member store by using the payment card that has been registered in Step S500 without presenting the point card (S504), the “member store (POS server)” gives payment authorization to the “credit/electronic money server” (S506).

The “credit/electronic money server” performs a payment process in accordance with the payment authorization in Step S506 (S508). Note that, in a case in which payment means is integrated circuit (IC) management type electronic money, the payment process is performed in an IC chip.

Further, the “credit/electronic money server” reflects content of the payment in a page for a member such as a payment personal page (S510). The content of the payment reflected by the “credit/electronic money server” is, for example, date and time, a price, a store, or the like related to the payment as illustrated in FIG. 6B.

When the payment process is normally completed, the “credit/electronic money server” transmits a notification that the payment has been normally completed to the “member store (POS server)” (S512).

When the notification that the payment has been normally completed is acquired from the “credit/electronic money server”, the “member store (POS server)” records POS data (S514).

After the process in Step S514 is performed, the purchased commodity is handed over to the user in the member store (S516).

### [2-4-3] Process Related to Information Processing Method According to Embodiment (FIG. 6C)

The information processing device according to the embodiment logs in to the “credit/electronic money server” (S518) and acquires payment history data (S520). Then, the information processing device according to the embodiment checks whether or not there is updated data that has been updated since the last access to the “credit/electronic money server” (S522)

Herein, the processes in Steps S518 to S522 are regularly (or irregularly) and repeatedly performed.

In a case in which there is updated data, the information processing device according to the embodiment performs the above process (1) (association process) and the above process (2) (transmission process), thereby transmitting associated payment history data (an example of the payment information) and point card ID (an example of the giving information) to the “member store (POS server)” (S524).

Herein, in a case in which a transmission target is the “point service provider server” corresponding to the second processing device, the information processing device according to the embodiment transmits the associated payment history data (an example of the payment information) and point card ID (an example of the giving information) to the point service provider server” in Step S524. Further, in a case in which the associated payment history data and point card ID (an example of the giving information) are transmitted to the “point service provider server”, processes in Steps S526 to S530 described below are performed in, for example, the “point service provider server”.

The “member store (POS server)” checks whether or not there is POS data corresponding to the acquired payment history data (an example of the payment information) (S526).

In a case in which there is POS data corresponding to the acquired payment history data, the “member store (POS server)” transmits a point giving request including the corresponding POS data and the acquired point card ID (an example of the giving information) to the “point service provider server” (S528).

Note that the “member store (POS server)” may transmit the above point giving request to the information processing device according to the embodiment. In a case in which the above point giving request is transmitted to the information processing device according to the embodiment, the information processing device according to the embodiment transmits the point giving request to the “point service provider server”.

Further, in a case in which there is no POS data corresponding to the acquired payment history data, the “member store (POS server)” transmits a notification that there is no corresponding POS data to the information processing device according to the embodiment (S530).

### [2-4-4] Process Related to Giving a Point (FIG. 6D)

The “point service provider server” that has acquired the point giving request determines whether or not a point based on payment corresponding to the POS data has already been given on the basis of the POS data and the point card ID included in the point giving request (S532).

In a case in which it is determined that a point based on payment corresponding to the POS data has already been given in Step S532, the “point service provider server” transmits a notification that the payment is not a target to which a point is given to the “member store (POS server)” (S534).

Further, in a case in which it is not determined that a point based on payment corresponding to the POS data has already been given in Step S532, the “point service provider server” gives a point (S536). The “point service provider server” calculates points to be given to the user on the basis of, for example, the content of the payment such as content of the purchased commodity and a payment place, a point ID, or the like. Then, the “point service provider server” gives the points by adding the calculated points to points that have already been given to the above point ID. For example, the “point service provider server” gives the points by updating a point management table. Further, the “point service provider server” can calculate points to be given by an arbitrary calculation method based on a set regulation.

By performing the process in Step S536, a point based on, for example, the payment related to the purchase of the commodity illustrated in FIG. 6B is given to the user associated with the payment card without the user presenting the point card.

Note that the information processing device according to the embodiment may access the “point service provider server” to check a change in points at an arbitrary timing after the process in Step S524 of FIG. 6C is performed (S538). The information processing device according to the embodiment can access the “point service provider server” at an arbitrary timing by using the information registered in S500 of FIG. 6A.

Further, in a case in which the points given to the user are changed in Step S538, the information processing device according to the embodiment may transmit a notification of the given points to the user (S540). The information processing device according to the embodiment transmits a notification to, for example, a notification destination such as an email address registered by the registration operation in Step S500 of FIG. 6A or registration operation performed by the user at an arbitrary timing. Note that the notification method in Step S540 is not limited to the above method, and the information processing device according to the embodiment can use an arbitrary method capable of transmitting a notification of the given points to the user.

By performing, for example, the processes illustrated in FIGS. 6A to 6D, the information processing system according to the embodiment achieves, for example, “giving a point based on payment related to a purchase of a commodity to a user associated with a payment card without the user presenting a point card”.

Note that it is regardless to say that an example of the process in the information processing system according to the embodiment is not limited to the processes illustrated in FIGS. 6A to 6D.

### [3] Examples of Effect Achieved by Using Information Processing Method According to Embodiment

The information processing device according to the embodiment performs the point giving control process related to the information processing method according to the embodiment, thereby achieving, for example, the following effects. Note that it is regardless to say that effects achieved by using the information processing method according to the embodiment are not limited to the following effects.

A user can acquire a point on the basis of payment without presenting a point card or the like. Further, because it is unnecessary to present the point card or the like to acquire a point, the user does not need to bring the point card or the like. This makes it possible to improve convenience for the user.

Because a point is given to the user on the basis of payment even in a case in which the point card or the like is not presented, it is possible to simulatively achieve presentation of the point card or the like by performing payment.

Because presentation of the point card or the like is simulatively achieved by performing payment as described above, a rate of presentation of the point card or the like is increased in a member store. Therefore, the member store and a provider who provides a common point service can obtain advantages achieved by providing the point service more securely.

Because presentation of the point card or the like is simulatively achieved by performing payment as described above, it is possible to eliminate a burden on the user in presenting the point card or the like and a burden on a salesperson in the member store in performing operation related to provision of an existing point service. Therefore, burdens on the user and the salesperson are reduced.

Because the burdens on the user and the salesperson are reduced as described above, it is possible to reduce processing time in a register of the member store, and an increase in sales is expected. Further, because the burden in performing operation related to provision of the existing point service can be eliminated, it is possible to cut costs of education related to the operation to a salesperson.

Because presentation of the point card or the like is simulatively achieved by performing payment as described above, it is possible to reduce infrastructure costs for conducting a point service, such as reading a point card, cooperation with a POS device, and connection to a server that performs a process of giving a point. Further, when focusing only on giving a point based on a purchase, it is unnecessary to make an investment in infrastructure necessary for a process using the point card or the like in the member store. Furthermore, because it is unnecessary to make an investment in infrastructure as described above, it is possible to reduce, for example, a lead time taken for a store or the like to newly become a member store.

### (Information Processing Device According to Embodiment)

Next, an example of a configuration of the information processing device according to the embodiment capable of performing the process related to the information processing method according to the embodiment described above will be described.

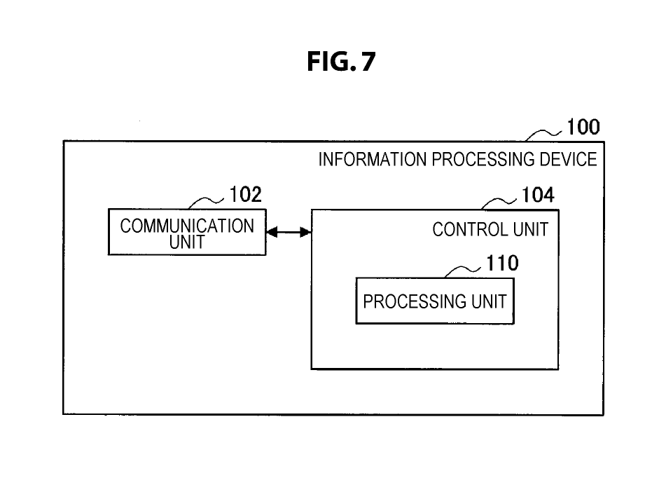

FIG. 7 is a block diagram illustrating an example of a configuration of an information processing device 100 according to the embodiment. The information processing device 100 includes, for example, a communication unit 102 and a control unit 104.

Moreover, for example, the information processing device 100 may include, a read-only memory (ROM which is not illustrated), a random access memory (RAM which is not illustrated), a storage unit (not illustrated), a manipulation unit (not illustrated) which can be manipulated by a user, and a display unit (not illustrated) that displays various screens on a display screen. In the information processing device 100, for example, the constituent elements are connected via a bus serving as a data transmission path.

The ROM (not illustrated) stores a program or control data such as calculation parameters which are used by the control unit 104. The RAM (not illustrated) temporarily stores a program or the like which is executed by the control unit 104.

The storage unit (not illustrated) is storage means included in the information processing device 100 and stores, for example, data related to the information processing method according to the embodiment, such as setting information and various kinds of data such as various applications. Here, as the storage unit (not illustrated), for example, a magnetic recording medium such as a hard disk and a nonvolatile memory such as a flash memory can be exemplified. Moreover, the storage unit (not illustrated) may be detachably mounted on the information processing device 100.

As the manipulation unit (not illustrated), a manipulation input device to be described below can be exemplified. Moreover, as the display unit (not illustrated), a display device to be described below can be exemplified.

### [Example of Hardward Configuration of Information Processing Device 100]

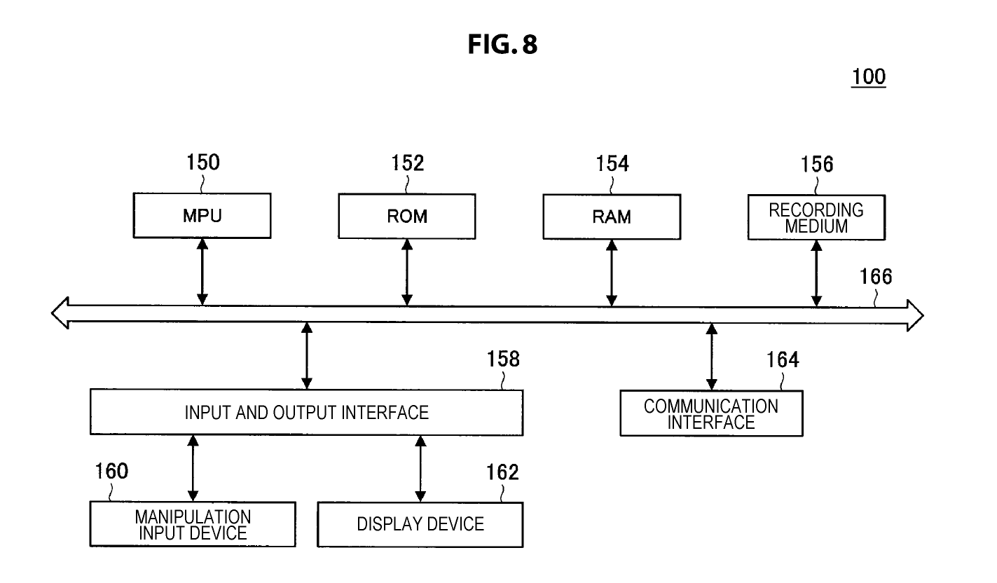

FIG. 8 is an explanatory diagram illustrating an example of a hardware configuration of the information processing device 100 according to the embodiment. The information processing device 100 includes, for example, an MPU 150, a ROM 152, a RAM 154, a recording medium 156, an input and output interface 158, a manipulation input device 160, a display device 162, and a communication interface 164. Moreover, in the information processing device 100, for example, the constituent elements are connected via a bus 166 serving as a data transmission path.

For example, the MPU 150 includes one or two or more processors or various processing circuits including a calculation circuit such as an MPU, and functions as the control unit 104 controlling the entire information processing device 100. Moreover, the MPU 150 plays roles of, for example, the processing unit 110 to be described below in the information processing device 100. In addition, the processing unit 110 may include a dedicated (or general-purpose) circuit (for example, a processor different from the MPU 150) capable of realizing a process of the processing unit 110.

The ROM 152 stores a program or control data such as calculation parameters which is used by the MPU 150. For example, the RAM 154 temporarily stores a program or the like which is executed by the MPU 150.

The recording medium 156 functions as a storage unit (not illustrated) and stores, for example, data related to the information processing method according to the embodiment, such as setting information and various kinds of data such as various applications. Here, as the recording medium 156, for example, a magnetic recording medium such as a hard disk and a nonvolatile memory such as a flash memory can be exemplified. Moreover, the recording medium 156 may be detachably mounted on the information processing device 100.

The input and output interface 158 connects, for example, the manipulation input device 160 or the display device 162. The manipulation input device 160 functions as a manipulation unit (not illustrated) and the display device 162 functions as a display unit (not illustrated). Here, as the input and output interface 158, for example, a Universal Serial Bus (USB) terminal, a Digital Visual Interface (DVI) terminal, a High-Definition Multimedia Interface (HDMI) (registered trademark) terminal, and various processing circuits can be exemplified.

Moreover, for example, the manipulation input device 160 can be installed on the information processing device 100 and is connected to the input and output interface 158 inside the information processing device 100. As the manipulation input device 160, for example, a button, an arrow key, a rotary selector such as a jog dial, or a combination thereof can be exemplified.

Moreover, for example, the display device 162 can be installed on the information processing device 100 and is connected to the input and output interface 158 inside the information processing device 100. As the display device 162, for example, a liquid crystal display or an organic electro-luminescence display (or also referred to as an organic light emitting diode display) can be exemplified.

In addition, it is regardless to say that the input and output interface 158 can be connected to an external device such as an external manipulation input device (for example, a keyboard or a mouse) or an external display device of the information processing device 100. Moreover, the display device 162 may be, for example, a device in which display and a user manipulation are possible, such as a touch panel.

The communication interface 164 is communication means included in the information processing device 100 and functions as the communication unit 102 that performs wireless or wired communication with an external device such as the first processing device including a POS device of a member store or the second processing device including a server or the like of a point service provider via a network (or directly). Here, as the communication interface 164, for example, a communication antenna and a radio frequency (RF) circuit (for wireless communication), an IEEE 802.15.1 port and a transmission and reception circuit (for wireless communication), an IEEE 802.11 port and a transmission and reception circuit (for wireless communication), or a Local Area Network (LAN) terminal and a transmission and reception circuit (for wired communication) can be exemplified.

The information processing device 100 that has, for example, the configuration illustrated in FIG. 8 performs the process related to the information processing method according to the embodiment. In addition, a hardware configuration of the information processing device 100 according to the embodiment is not limited to the configuration illustrated in FIG. 8.

For example, the information processing device 100 does not have to include the communication interface 164 in a case in which communication with an external device is performed via a connected external communication device. Moreover, the communication interface 164 may be capable of performing communication with one or two or more external devices in conformity with a plurality of communication schemes.

Moreover, for example, the information processing device 100 does not have to include the recording medium 156, the manipulation input device 160, or the display device 162.

Moreover, a part or the whole of the structural elements illustrated in FIG. 8 (or a configuration according to a modification example) may be realized by one or two or more ICs.

Referring back to FIG. 7, an example of the configuration of the information processing device 100 will be described. The communication unit 102 is communication means included in the information processing device 100 and performs wireless or wired communication with an external device such as the first processing device including a POS device of a member store or the second processing device including a server or the like of a point service provider via a network (or directly). Moreover, the communication of the communication unit 102 is controlled by, for example, the control unit 104.

Here, as the communication unit 102, for example, a communication antenna and an RF circuit or a LAN terminal and a transmission and reception circuit can be exemplified. However, the configuration of the communication unit 102 is not limited to the foregoing configuration. For example, the communication unit 102 can have a configuration corresponding to any standard capable of performing communication, such as a USB terminal and a transmission and reception circuit or have any configuration capable of communicating an external device via a network. Moreover, the communication unit 102 may have a configuration capable of performing communication with one or two or more external devices in conformity with a plurality of communication schemes.

The control unit 104 is implemented by, for example, an MPU and plays a role in controlling the entire information processing device 100. Moreover, the control unit 104 includes, for example, the processing unit 111 and plays a role in leading the process related to the information processing method according to the embodiment.

The processing unit 110 plays a role in leading the point giving control process according to the embodiment and associates payment information with giving information to cause the associated payment information and giving information to be transmitted to a transmission target. More specifically, the processing unit 110 performs, for example, the above process (1) (association process) and the above process (2) (transmission process)

The control unit 104 includes, for example, the processing unit 110 and therefore plays a role in leading the process related to the information processing method according to the embodiment (e.g., the point giving control process according to the embodiment).

The information processing device 100 that has, for example, the configuration illustrated in FIG. 7 performs the process related to the information processing method according to the embodiment the point giving control process according to the embodiment).

Therefore, the information processing device 100 that has, for example, the configuration illustrated in FIG. 7 can achieve giving a point based on payment without requiring that a user present a card or the like for receiving a point service.

Moreover, the information processing device 100 that has, for example, the configuration illustrated in FIG. 7 can achieve the effects by performing the process related to the information processing method according to the embodiment described above.

In addition, the configuration of the information processing device according to the embodiment is not limited to the configuration illustrated in FIG. 7.

For example, the information processing device according to the embodiment can include the processing unit 110 illustrated in FIG. 7 (which is realized with, for example, another processing circuit) separately from the control unit 104.

Further, as described above, the point giving control process according to the embodiment is obtained by prescribing the process in the information processing method according to the embodiment for convenience sake. Therefore, a configuration for achieving the process related to the information processing method according to the embodiment is not limited to the configuration illustrated in FIG. 7, and it is possible to have a configuration based on how to separate the process related to the information processing method according to the embodiment.

Moreover, for example, in a case in which communication with an external device is performed via an external communication device that has similar function and configuration to the communication unit 102, the information processing device according to the embodiment does not have to include the communication unit 102.

The information processing device has been described above as the embodiment, but the embodiment is not limited thereto. For example, the embodiment can be applied to various devices capable of performing the process related to the information processing method according to the embodiment, such as a computer such as a personal computer (PC) or a server. Moreover, for example, the embodiment can also be applied to a processing IC which can be embedded in the above-described device.

Further, the information processing device according to the embodiment may be applied to a processing system in which, for example, connection to a network such as cloud computing (or communication between devices) is presupposed. An example of the processing system in which the process related to the information processing method according to the embodiment is performed is, for example, a system in which the above process (1) (association process) is performed by a single device forming the processing system and the above process (2) (transmission process) is performed by another device forming the processing system.

### (Program According to Embodiment)

A program that causes a computer to function as the information processing device according to the embodiment (e.g., a program capable of executing the process related to the information processing method according to the embodiment, such as the point giving control process according to the embodiment) is executed by a processor or the like in the computer. Therefore, it is possible to achieve giving a point based on payment without requiring that a user present a card or the like for receiving a point service.

Moreover, when a program that causes a computer to function as the information processing device according to the present embodiment is executed by a processor or the like in the computer, it is possible to provide an effect provided by the processing related to the information processing method according to the present embodiment described above.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, it has been illustrated above that a program (computer program) that causes a computer to function as the information processing device according to the present embodiment is provided, but the present embodiment can further provide a recording medium in which the above-described program is stored together.

The above-described configurations express examples of the present embodiment and, of course, pertain to the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1)

An information processing device including

a processing unit configured to associate payment information with giving information used to give a point, and cause the payment information and the giving information that are associated with each other to be transmitted to a transmission target.
(2)

The information processing device according to (1), in which

the processing unit specifies the giving information to be associated with the payment information on a basis of the payment information.
(3)

The information processing device according to (2), in which

in a case in which there are a plurality of pieces of the giving information capable of being associated with the payment information, the processing unit specifies a piece of giving information to be associated with the payment information further on a basis of setting information for specifying the piece of giving information.
(4)

The information processing device according to (3), in which

priorities of points to be given are set in the setting information, and

the processing unit specifies, as the giving information to be associated with the payment information, a piece of giving information used to give a point having a higher priority among the plurality of pieces of giving information.
(5)

The information processing device according to (3), in which

priorities of points to he given in respective payment places are set in the setting information, and

the processing unit specifies, as the giving information to be associated with the payment information, a piece of giving information used to give a point having a higher priority in a payment place indicated by the payment information among the plurality of pieces of giving information.
(6)

The information processing device according to (3), in which

priorities of points to be given for respective payment methods are set setting information, and

the processing unit specifies, as the giving information to be associated with the payment information, a piece of giving information used to give a point having a higher priority by a payment method indicated by the payment information among the plurality of pieces of giving information.
(7)

The information processing device according to (3), in which

earning rates of points to be given on a basis of content of payments are set in the setting information, and

the processing unit specifies, as the giving information to be associated with the payment information, a piece of giving information used to give a point having a higher earning rate based on content of a payment indicated by the payment information, among the plurality of pieces of giving information.
(8)

The information processing device according to (2), in which

in a case in which there are a plurality of pieces of the giving information capable of being associated with the payment information, the processing unit specifies a piece of giving information to be associated with the payment information on a basis of a state related to a point.
(9)

The information processing device according to (8), in which

the state related to a point is a state of giving the point, and

the processing unit specifies, as the giving information to be associated with the payment information, a piece of giving information used to give a same type of a point as a point that has already been given and that is larger in amount, among the plurality of pieces of giving information.
(10)

The information processing device according to (8), in which

the state related to a point is a usage state of the point, and

the processing unit specifies, as the giving information to be associated with the payment information, a piece of giving information used to give a point having a higher usage frequency among the plurality of pieces of giving information.
(11)

The information processing device according to (8), in which

the state related to a point is a state of an expiration date of the point, and

the processing unit specifies, as the giving information to be associated with the payment information, a piece of giving information used to give a same type of a point as a point that has already been given and whose expiration date is closer, or a piece of giving information used to give a point whose expiration date is further away, among the plurality of pieces of giving information.
(12)

The information processing device according to any one of (1) to (11), in which

the payment information includes one or two or more pieces of information for specifying sales information in a payment place.
(13)

The information processing device according to (12), in which

the one or two or more pieces of information included in the payment information are specified on a basis of receipt information.
(14)

The information processing device according to (12), in which

the one or two or more pieces of information included in the payment information are acquired from an external device.
(15)

The information processing device according to anyone of (1) to (14), in which

the processing unit causes the payment information and the giving information that are associated with each other to be transmitted to a transmission target set in advance.
(16)

The information processing device according to any one of (1) to (14), in which

the processing unit causes the payment information and the giving information that are associated with each other to be transmitted to a transmission target determined on a basis of the payment information.
(17)

An information processing method executed by an information processing device, the information processing method including

a step of associating payment information with giving information used to give a point and causing the payment information and the giving information that are associated with each other to be transmitted to a transmission target.
(18)

An information processing system including:

an information processing device including a processing unit configured to associate payment information with giving information used to give a point and configured to cause the payment information and the giving information that are associated with each other to be transmitted to a first processing device serving as a transmission target; and

the first processing device configured to cause a process of giving a point to be performed on a basis of the acquired payment information and giving information and sales information of a payment place.
(19)

An information processing system including:

an information processing device including a processing unit configured to associate payment information with giving information used to give a point and configured to cause the payment information and the giving information that are associated with each other to be transmitted to a second processing device serving as a transmission target; and

the second processing device configured to perform a process of giving a point on a basis of the acquired payment information and giving information and sales information of a payment place.
(20)

An information processing system including:

an information processing device including a processing unit configured to associate payment information with giving information used to give a point and configured to cause the payment information and the giving information that are associated with each other to be transmitted to a first processing device serving as a transmission target;

the first processing device configured to cause a second processing device to perform a process of giving a point on a basis of the payment information and the giving information that are acquired from the information processing device and sales information of a payment place; and

the second processing device configured to perform the process of giving a point on a basis of the sales information and the giving information that are acquired from the first processing device.

### REFERENCE SIGNS LIST

100 information processing device
102 communication unit
104 control unit
110 processing unit

1. An information processing device comprising
a processing unit configured to associate payment information with giving information used to give a point, and cause the payment information and the giving information that are associated with each other to be transmitted to a transmission target.

2. The information processing device according to claim 1, wherein
the processing unit specifies the giving information to be associated with payment information on a basis of the payment information.

3. The information processing device according to claim 2, wherein
in a case in which there are a plurality of pieces of the giving information capable of being associated with the payment information, the processing unit specifies a piece of giving information to be associated with the payment information further on a basis of setting information for specifying the piece of giving information.

4. The information processing device according to claim 3, wherein
priorities of points to be given are set in the setting information, and
the processing unit specifies, as the giving information to be associated with the payment information, a piece of giving information used to give a point having a higher priority among the plurality of pieces of giving information.

5. The information processing device according to claim 3, wherein
priorities of points to be given in respective payment places are set in the setting information, and
the processing unit specifies, as the giving information to be associated with the payment information, a piece of giving information used to give a point having a higher priority in a payment place indicated by the payment information among the plurality of pieces of giving information.

6. The information processing device according to claim 3, wherein
priorities of points to be given for respective payment methods are set in the setting information, and
the processing unit specifies, as the giving information to be associated with the payment information, a piece of giving information used to give a point having a higher priority by a payment method indicated by the payment information among the plurality of pieces of giving information.

7. The information processing device according to claim 3, wherein
earning rates of points to he given on a basis of content of payments are set in the setting information, and
the processing unit specifies, as the giving information to be associated with the payment information, a piece of giving information used to give a point having a higher earning rate based on content of a payment indicated by the payment information, among the plurality of pieces of giving information,

8. The information processing device according to claim 2, wherein
in a case in which there are a plurality of pieces of the giving information capable of being associated with the payment information, the processing unit specifies a piece of giving information to be associated with the payment information on a basis of a state related to a point.

9. The information processing device according to claim 8, wherein
the state related to a point is a state of giving the point, and
the processing unit specifies, as the giving information to be associated with the payment information, a piece of giving information used to give a same type of a point as a point that has already been given and that is larger in amount, among the plurality of pieces of giving information.

10. The information processing device according to claim 8, wherein
the state related to a point is a usage state of the point, and
the processing unit specifies, as the giving information to be associated with the payment information, a piece of giving information used to give a point having a higher usage frequency among the plurality of pieces of giving information.

11. The information processing device according to claim 8, wherein
the state related to a point is a state of an expiration date of the point, and
the processing unit specifies, as the giving information to be associated with the payment information, a piece of giving information used to give a same type of a point as a point that has already been given and whose expiration date is closer, or a piece of giving information used to give a point whose expiration date is further away, among the plurality of pieces of giving information.

12. The information processing device according to claim 1, wherein
the payment information includes one or two or more pieces of information for specifying sales information in a payment place.

13. The information processing device according to claim 12, wherein
the one or two or more pieces of information included in the payment information are specified on a basis of receipt information.

14. The information processing device according to claim 12, wherein
the one or two or more pieces of information included in the payment information are acquired from an external device.

15. The information processing device according to claim 1, wherein
the processing unit causes the payment information and the giving information that are associated with each other to be transmitted to a transmission target set in advance.

16. The information processing device according to claim 1, wherein
the processing unit causes the payment information and the giving information that are associated with each other to be transmitted to a transmission target determined on a basis of the payment information.

17. An information processing method executed by an information processing device, the information processing method comprising
a step of associating payment information with giving information used to give a point and causing the payment information and the giving information that are associated with each other to be transmitted to a transmission target.

18. An information processing system comprising:
an information processing device including a processing unit configured to associate payment information with giving information used to give a point and configured to cause the payment information and the giving information that are associated with each other to be transmitted to a first processing device serving as a transmission target; and
the first processing device configured to cause a process of giving a point to be performed on a basis of the acquired payment information and giving information and sales information of a payment place.

19. An information processing system comprising:
an information processing device including a processing unit configured to associate payment information with giving information used to give a point and configured to cause the payment information and the giving information that are associated with each other to be transmitted to a second processing device serving as a transmission target; and
the second processing device configured to perform a process of giving a point on a basis of the acquired payment information and giving information and sales information of a payment place.

20. An information processing system comprising:
an information processing device including a processing unit configured to associate payment information with giving information used to give a point and configured to cause the payment information and the giving information that are associated with each other to be transmitted to a first processing device serving as a transmission target.
the first processing device configured to cause a second processing device to perform a process of giving a point on a basis of the payment information and the giving information that are acquired from the information processing device and sales information of a payment place; and
the second processing device configured to perform the process of giving a point on a basis of the sales information and the giving information that are acquired from the first processing device.
